(19) United States
(12) Patent Application Publication
(10) Pub. No.: US 2008/0094465 A1
(43) Pub. Date: Apr. 24, 2008

(54) Image Recording Device and Image Recording Method

(76) Inventor: Hirokazu Okutsu, Kanagawa (JP)

Correspondence Address: TAIYO CORPORATION, 401 HOLLAND LANE, #407, ALEXANDRIA, VA, 22314, US

(21) Appl. No.: 11/661,794

(22) PCT Filed: Sep. 29, 2005
(86) PCT No.: PCT/JP05/18503

§ 371 Date: Mar. 1, 2007

(30) Foreign Application Priority Data
Sep. 30, 2004 (JP) 2004-288908

(51) Int. Cl. B41J 2/435

(52) U.S. Cl. 347/248

(57) ABSTRACT

An image recording device, which records an image on an image-drawing region of a strip-shaped flexible substrate stretched between a supply reel and a take-up reel, includes: a stage section for suctioning and conveying the flexible substrate; an alignment section for sensing an alignment mark of the flexible substrate; a correcting section which, on the basis of the sensed alignment mark, corrects image data to be recorded on the flexible substrate; and a recording section for recording the image data corrected by the correcting section on the flexible substrate. The stage section suctions the flexible substrate and moves reciprocatingly along a conveying path. On an outward trip, the alignment section senses the alignment mark of the flexible substrate, and on a return trip, the recording section records the image data corrected by the correcting section.

### BACKGROUND OF THE INVENTION

1. Field of the Invention

The present invention relates to an image recording device and an image recording method which record an image on an image-drawing region of a strip-shaped flexible substrate stretched between a supply reel and a take-up reel.

2. Description of the Related Art

Conventionally, image recording devices have been known which, while feeding-out a flexible printed circuit (flexible substrate) which is wound in the form of a roll, record images on image-drawing regions thereof. Such an image recording device has a loader, an unloader and a stage member. The loader has a supply reel on which is set the flexible printed circuit which is wound in the form of a roll. The unloader has a take-up reel which takes-up the flexible printed circuit, on which images have been recorded, in the form of a roll. The stage member is disposed between the loader and the unloader, and temporarily fixes the flexible printed circuit.

Accordingly, the flexible printed circuit is placed on the stage member in a state of being stretched between the loader and the unloader, and, on the stage member, an image is recorded in the image-drawing region by an exposure section. Then, when recording of the image is completed, the flexible printed circuit is conveyed by a predetermined amount due to the driving of the loader and the unloader. The next image-drawing region is placed on and fixed to the stage member, and is exposed. By repeating these operations successively, images are recorded on the image-drawing regions of the flexible printed circuit which is wound in the form of a roll.

Marks for positioning (hereinafter called “alignment marks”), which demarcate the image-drawing regions and which are for enabling position correction with respect to the exposure section, are provided at the flexible printed circuit. Namely, a camera for reading the alignment marks is provided at the image recording device. On the basis of the position data of the alignment marks read by the camera, the recording position of the image data onto the flexible printed circuit (the image drawing region) is corrected (see, for example, Japanese Patent Application Laid-Open (JP-A) No. 2000-227661).

In an image recording device of such a structure, by reading the alignment marks of the flexible printed circuit which is placed on and fixed to the stage member, the positional offset (oblique feeding) in the direction orthogonal to the conveying direction can be corrected. (Hereinafter, the direction orthogonal to the conveying direction will be referred to as the “main scanning direction” or the “transverse direction”.) However, the positional offset (elongation) in the conveying direction of the flexible printed circuit (the subscanning direction) cannot be corrected.

Namely, the flexible printed circuit has elasticity of a certain extent, and is stretched in a state in which tension of a certain extent is applied thereto by the loader and the unloader. Therefore, the flexible printed circuit is conveyed in a state in which is elongated slightly in the conveying direction (the subscanning direction). Accordingly, if an image is recorded (formed) the image may deform when the tension is eliminated.

### SUMMARY OF THE INVENTION

A first aspect of the present invention provides an image recording device for recording an image on an image-drawing region of a strip-shaped flexible substrate stretched between a supply reel and a take-up reel, the device including: a predetermined conveying path of the flexible substrate, the conveying path being demarcated between the supply reel and the take-up reel; a stage section for suctioning the flexible substrate, and structured so as to be reciprocatingly movable along the conveying path; an alignment section disposed at the conveying path above the stage section, and which, on a outward trip of the stage section, senses at least an alignment mark of the flexible substrate; a correcting section which, on the basis of the alignment mark sensed by the alignment section, corrects image data to be recorded on the image-drawing region of the flexible substrate; and a recording section disposed at the conveying path above the stage section, and which, on a return trip of the stage section, records the image data corrected by the correcting section at the image-drawing region of the flexible substrate.

In accordance with the first aspect, because the stage member suctions and conveys the flexible substrate, the occurrence of oblique feeding and wrinkles and the like is prevented. Further, because the alignment processing is carried out on the outward trip (forward movement) and the image recording processing is carried out on the return trip (reverse movement), at a single image-drawing region, the alignment processing can be completed before the image recording processing.

In the image recording device of the first aspect, the correcting section may be structured so as to be able to at least compute a positional offset correction amount with respect to a conveying direction of the flexible substrate.

Alignment processing can thereby be carried out with respect to the positional offset in the conveying direction of the flexible substrate (i.e., the elongation). Accordingly, an image can be accurately recorded on the flexible substrate.

Further, the recording section and the alignment section may be disposed in that order from the supply reel side.

In this way, the carrying out of alignment processing on the outward trip and the carrying out of image recording processing on the return trip can be executed efficiently.

Moreover, the flexible substrate may be conveyed-in and discharged-out with the image-drawing region of the flexible substrate suctioned to the stage section.

Due to the flexible substrate being conveyed-in and discharged-out with the image-drawing region thereof suctioned to the stage section, there is no need for separate mechanisms or the like for conveying-in and discharging the flexible substrate.

The flexible substrate may be conveyed to the stage section and discharged from the stage section by conveying rollers.

In this way, the tact time until one image-drawing region is processed can be reduced as compared with a case in which the flexible substrate is conveyed-in and discharged-out by the stage section.

Further, the recording section may have an exposure head which exposes the flexible substrate and records the image data.

The exposure head may be structured so as to irradiate a light beam, which is modulated on the basis of the image data, and expose the flexible substrate.

In accordance with a second aspect of the present invention, there is provided an image recording method for recording an image on an image-drawing region of a strip-shaped flexible substrate stretched between a supply reel and a take-up reel, the method including: moving, along a predetermined conveying path, a stage section which for suctioning the flexible substrate; sensing, by an alignment section, at least an alignment mark of the flexible substrate; on the basis of the sensed alignment mark, correcting image data to be recorded on the image-drawing region of the flexible substrate; and recording, by a recording section, corrected image data on the image-drawing region of the flexible substrate, while moving the stage section in an opposite direction.

In accordance with the second aspect, because the stage member suctions and conveys the flexible substrate, the occurrence of oblique feeding and wrinkles and the like is prevented. Further, because the alignment processing is carried out on the outward trip and the image recording processing is carried out on the return trip, at a single image-drawing region, the alignment processing can be completed before the image recording processing.

The correcting section may be structured so as to be able to at least compute a positional offset correction amount with respect to a conveying direction of the flexible substrate.

Alignment processing can thereby be carried out with respect to the positional offset in the conveying direction of the flexible substrate (i.e., the elongation). Accordingly, an image can be accurately recorded on the flexible substrate.

Further, the recording section and the alignment section may be disposed in that order from the supply reel side.

In this way, the carrying out of alignment processing on the outward trip and the carrying out of image recording processing on the return trip can be executed efficiently.

Moreover, the flexible substrate may be conveyed-in and discharged-out with the image-drawing region of the flexible substrate suctioned to the stage section.

Due to the flexible substrate being conveyed-in and discharged-out with the image-drawing region thereof suctioned to the stage section, there is no need for separate mechanisms or the like for conveying-in and discharging the flexible substrate. The flexible substrate may be conveyed to the stage section and discharged from the stage section by conveying rollers.

In this way, the tact time until one image-drawing region is processed can be reduced as compared with a case in which the flexible substrate is conveyed-in and discharged-out by the stage section.

Further, the recording section may have an exposure head which exposes the flexible substrate and records the image data.

The exposure head may be structured so as to irradiate a light beam, which is modulated on the basis of the image data, and expose the flexible substrate.

Due to such a structure, the present invention can provide an image recording device and an image recording method which can accurately record an image on a flexible substrate.

### BRIEF DESCRIPTION OF THE DRAWINGS

An embodiment of the present invention will be described in detail based on the following figures, wherein:

FIG. 1 is a schematic perspective view of an image recording device according to an embodiment of the present invention;

FIG. 2 is a schematic side view of the image recording device;

FIG. 3A is a schematic plan view showing exposure regions of exposure heads, and

FIG. 3B is a schematic plan view showing an arrangement pattern of the exposure heads;

FIG. 4 is a schematic perspective view of an alignment section;

FIG. 5A is a schematic perspective view of a PD sensor when a cover is open, and

FIG. 5B is a schematic perspective view of the PD sensor when the cover is closed;

FIG. 6A is a schematic side view showing a state in which the exposure heads are scanned by the PD sensor, and FIG. 6B is a schematic side view showing a state in which a flexible printed circuit is set at an unloader by a stage member;

FIGS. 7A through 7F are schematic side views for explanation of processes of forming an image on the flexible printed circuit;

FIGS. 8A through 8D are schematic side views for explanation of other processes of forming an image on the flexible printed circuit;

FIG. 9 is a block diagram showing a control system which detects alignment marks; and

FIG. 10A is a schematic plan view showing the flexible printed circuit before being stretched between a loader and the unloader, and FIG. 10B is a schematic plan view showing the flexible printed circuit after being stretched between the loader and the unloader.

### DESCRIPTION OF THE PREFERRED EMBODIMENT

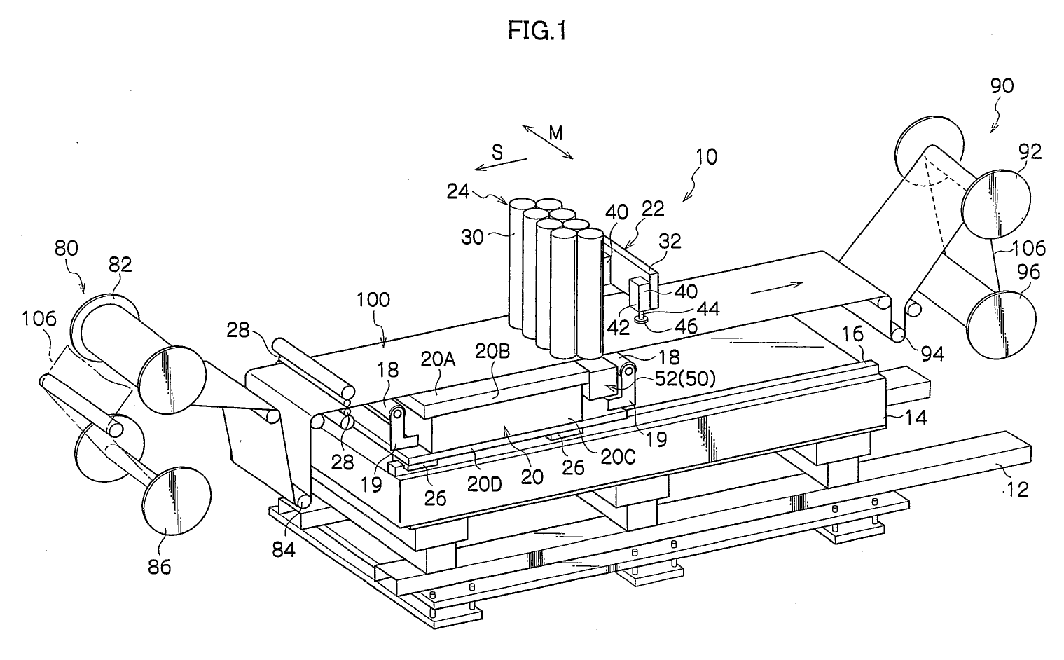

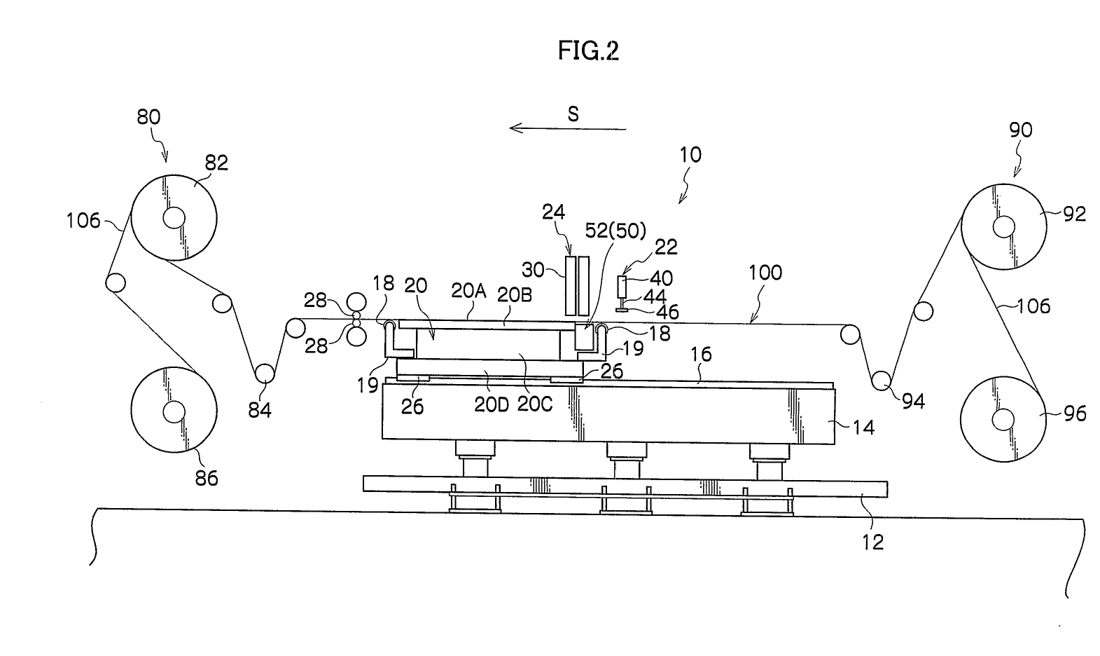

FIG. 1 is a schematic perspective view of an image recording device 10 relating to the present invention, and FIG. 2 is a schematic side view thereof. Note that, in FIG. 1, arrow M is a main scanning direction (transverse direction), arrow S is a subscanning direction, and the direction opposite to the subscanning direction is the conveying direction.

[Structure of Flexible Printed Circuit]

As shown in FIGS. 1 and 2, the recording medium, which is the object of the image recording device 10 relating to the present invention, is a flexible substrate (e.g., a flexible printed circuit 100) which is continuous in a strip-shaped form. In the flexible printed circuit 100, a metal thin film layer of copper foil or the like is formed on a flexible, film-like, insulating layer, and the metal thin film layer is laminated by a dry film resist. The flexible printed circuit 100 is wound in the form of a roll and set at a loader 80. Note that the flexible substrate may be any of various types of flexible recording media such as a substrate for a liquid crystal display, a filter, or the like, as well as the flexible printed circuit 100.

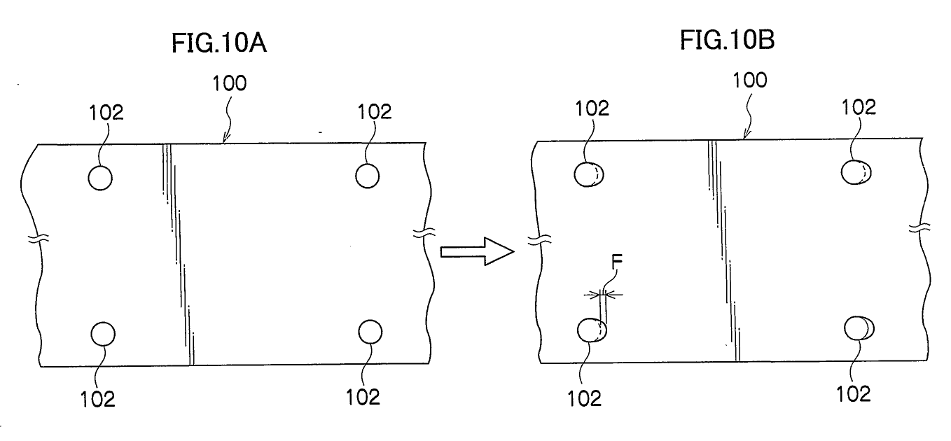

There are various types of the flexible printed circuit 100, such as a single-sided circuit in which a wiring pattern is formed only on one surface, a double-sided circuit in which wiring patters are formed on both surfaces, a multilayer circuit in which a layer at which a wiring pattern is formed is laminated at the outer side of a double-sided circuit, and the like. Further, a plurality of image-drawing regions (not shown) is set in advance on the exposure surface of the flexible printed circuit 100. Plural groups of alignment marks 102 (see FIG. 10A), which correspond to the respective image-drawing regions (and which are references for demarcating the respective image-drawing regions), are formed at predetermined positions of the flexible printed circuit 100.

[Structure of Image Recording Device]

As shown in FIGS. 1 and 2, the image recording device 10 is disposed between the loader 80 and an unloader 90. The loader 80 has a supply reel 82 which holds the unexposed flexible printed circuit 100 wound in the form of a roll, such that the flexible printed circuit 100 can be drawn-out therefrom. The unloader 90 has a take-up reel 92 which takes-up, in the form of a roll, the exposed flexible printed circuit 100 on which images have been recorded. Dancer rollers 84, 94, and the like, which adjust the tension which is applied to the flexible printed circuit 100, are disposed between the loader 80 and the image recording device 10 and between the unloader 90 and the image recording device 10.

The image recording device 10 has: a supporting stand 14 of a predetermined thickness, whose top surface is substantially shaped as a rectangle whose longitudinal direction is the subscanning direction (or the conveying direction); a stage member 20 movably supported by a pair of guide rails 16 which are disposed on the supporting stand 14 parallel to the subscanning direction (or the conveying direction), the stage member 20 suctioning and conveying, for each image-drawing region, the flexible printed circuit 100 which is stretched between the loader 80 and the unloader 90; an alignment section 22 sensing the alignment marks 102 of the flexible printed circuit 100 which is suctioned to and conveyed by the stage member 20; and an exposure section 24 exposing the image-drawing region of the flexible printed circuit 100 which is suctioned to and conveyed by the stage member 20; and the like.

Vibration-proofing rubbers (not shown) or the like are disposed between a frame 12 disposed horizontally on the floor and the supporting stand 14 disposed on the frame 12, such that vibrations from the floor are isolated. Further, a collecting reel 86, which collects a protective film 106 which was covering the flexible printed circuit 100, is disposed at the loader 80. A feed-out reel 96, which feeds-out the protective film 106 which is to cover the flexible printed circuit 100, is disposed at the unloader 90.

As described above, the pair of guide rails 16 are disposed on the top surface of the supporting stand 14, parallel to the subscanning direction (or the conveying direction), and the stage member 20 is disposed on the guide rails 16 so as to be reciprocatingly movable. The stage member 20 has: a supporting body 20B at which the configuration of a top surface (hereinafter “stage surface”) 20A thereof substantially is a rectangle whose longitudinal direction is the subscanning direction (or the conveying direction); a raising/lowering mechanism 20C which raises and lowers the supporting body 20B; and a base 20D which supports the raising/lowering mechanism 20C. A guide member 26, which is substantially shaped as an upside-down “U” in sectional view and which extends rectilinearly along the subscanning direction (the conveying direction) is mounted to each of the four corners of the bottom surface of the base 20D. The guide members 26 are slidably fit-together with the guide rails 16.

The structure which reciprocatingly moves the stage member 20 along the guide rails 16 is arbitrary. For example, a structure can be employed in which a tubular member (not shown), with which is screwed together a ball screw (not shown) disposed between the guide rails 16, is fixed at the center of the bottom surface of the base 20D, and a motor (not shown) is joined to one end of the ball screw, or the like. In accordance therewith, due to the ball screw being rotated in forward and reverse directions due to the rotational driving force of the motor, the stage member 20 can be moved reciprocatingly along the guide rails 16 on the supporting stand 14 via the tubular member.

An arbitrary structure can be employed for the structure of the raising/lowering mechanism 20C as well. For example, a structure which raises and lowers by an air cylinder (not shown) or the like can be used.

A large number of small holes (not shown) are formed in the stage surface 20A of the stage member 20, and the interior of the supporting body 20B which includes the stage surface 20A is hollow. The interior of the supporting body 20B is piped (configured) so as to become negative pressure. Namely, one end of a pipe (not shown), which is structured by a flexible tube, is connected to the supporting body 20B of the stage member 20 so as to not impede movement of the stage member 20, and the other end of the pipe is connected to a vacuum pump (not shown).

A switching valve (not illustrated), which is operated by an electric means, is disposed midway along the pipe. The interior of the supporting body 20B of the stage member 20 is set in a negative pressure state and the negative pressure state is cancelled, by this switching valve. In this way, the flexible printed circuit 100 is suctioned to the stage surface 20A of the stage member 20, and the suctioning thereof is released.

Guide rollers 18, which support the flexible printed circuit 100, for which suctioning by the stage member 20 has been released, from the reverse surface (bottom surface) side of the flexible printed circuit 100, are disposed at the conveying direction side and the subscanning direction side of the stage member 20, so as to be parallel to the main scanning direction (the transverse direction). The guide rollers 18 are supported so as to be freely rotatable at brackets 19 which are mounted to the both end portions of the conveying direction side and the subscanning direction side of the base 20D, and move together with the stage member 20. However, even if the stage member 20 is raised or lowered, the heights of the guide rollers 18 do not change.

Cleaning rollers 28, which clean at least the exposure surface (the image-drawing regions) of the flexible printed circuit 100, are disposed parallel to the main scanning direction (the transverse direction) between the supporting stand 14 and the dancer roller 84. The cleaning rollers 28 are structured so as to slidingly contact the flexible printed circuit 100 and move away from the flexible printed circuit 100 at predetermined times.

The exposure section 24 has a plurality of exposure heads 30. Each exposure head 30 is supported, so as to face downward, at a supporting member (not shown) provided above the substantial center in the subscanning direction (or the conveying direction) of the supporting stand 14. When the flexible printed circuit 100 passes by an exposure position directly beneath the supporting member, plural laser beams, which are modulated on the basis of image data, are illuminated from above onto the exposure surface (the image-drawing region) of the flexible printed circuit 100, such that an image (a latent image) is formed (recorded) on the exposure surface.

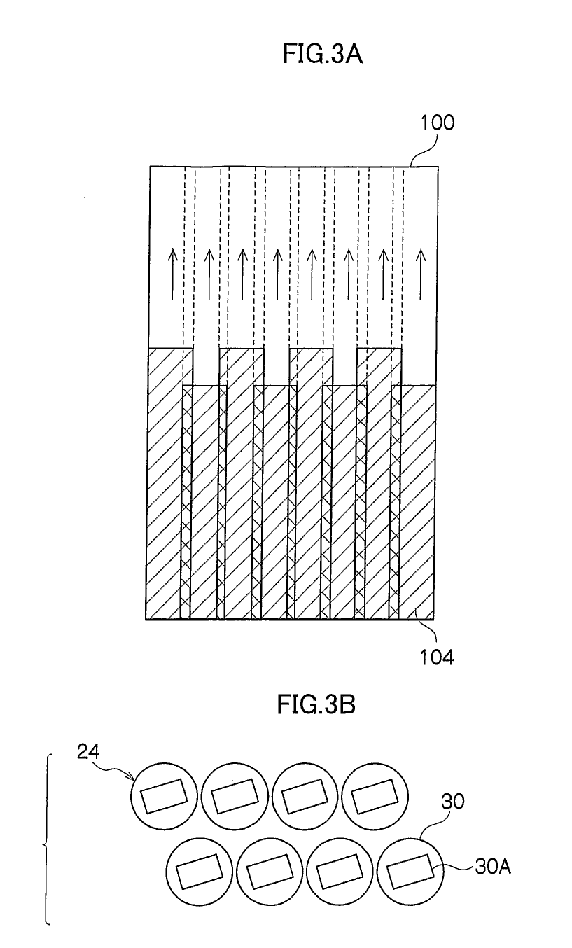

As shown in FIG. 3B, the exposure heads 30 are disposed along the transverse direction of the supporting stand 14 (the main scanning direction) in plural lines and plural columns, e.g., a matrix form of two lines and four columns), and are offset from one another so as to be staggered (i.e., alternately) with respect to one another as seen in plan view. Accordingly, exposed regions 104 such as shown in FIG. 3A are formed.

Namely, the exposure heads 30 are lined-up in the main scanning direction (the transverse direction) which is orthogonal to the subscanning direction (or the conveying direction) in which the stage member 20 moves. An exposure area 30A of the exposure head 30 is a rectangle whose short side is the subscanning direction (or the conveying direction), and which is inclined at a predetermined angle with respect to the subscanning direction (or the conveying direction). Accordingly, as the stage member 20 moves, the strip-shaped exposed region 104 is formed by each exposure head 30 on the flexible printed circuit 100.

A light source unit (not shown) is disposed at a place at which it cannot impede the movement of the stage member 20. A plurality of laser (semiconductor laser) generating devices (not shown) is housed in the light source unit. The lights exiting from the laser generating devices are guided, via optical fibers (not shown), to the respective exposure heads 30.

At each exposure head 30, the light beam which is guided thereto and made incident therein by the optical fiber, is controlled in units of dots by an unillustrated digital micromirror device (hereinafter, “DMD”) which is a spatial light modulator, and the exposure head 30 exposes a dot pattern on the flexible printed circuit 100. The density of one pixel is expressed by using a plurality of dot patterns.

The DMD is a mirror device in which a large number of micromirrors, at which the angles of the reflecting surfaces thereof are varied in accordance with control signals, are lined-up two-dimensionally in plural lines and plural columns on a semiconductor substrate formed of silicon or the like. Accordingly, when a single light is irradiated onto the DMD, plural lights can be modulated and controlled independently in accordance with the resolution. Namely, light beams (laser beams) can be modulated in accordance with image data.

Generally, the spatial light modulator such as the DMD or the like is arranged in the form of a matrix in which the lined-up direction of the respective lines and the lined-up direction of the respective columns are orthogonal to one another. When the DMD is disposed at an incline with respect to the subscanning direction (or the conveying direction), the intervals between the scan lines at the time of scanning become more narrow, and the resolution can be increased. Namely, by tilting the two-dimensionally arranged dot pattern with respect to the subscanning direction (or the conveying direction), the respective dots which are lined-up in the subscanning direction (or the conveying direction) pass through between the dots which are lined-up in the main scanning direction (the transverse direction) which intersects the subscanning direction (or the conveying direction). Accordingly, the substantial pitch between dots can be narrowed, and a higher resolution can be realized.

The alignment section 22 is disposed at the aforementioned supporting member at a predetermined position at the downstream side, in the conveying direction of the flexible printed circuit 100, of the exposure section 24. The alignment section 22 reads out the plural groups of alignment marks 102 (see FIG. 10A) provided at predetermined positions of the flexible printed circuit 100, in order to demarcate the image-drawing regions, and in order to compute position correction data of the flexible printed circuit 100, in particular, the positional offset amount in the conveying direction (the ratio of expansion/contraction due to elongation F, see FIG. 10B).

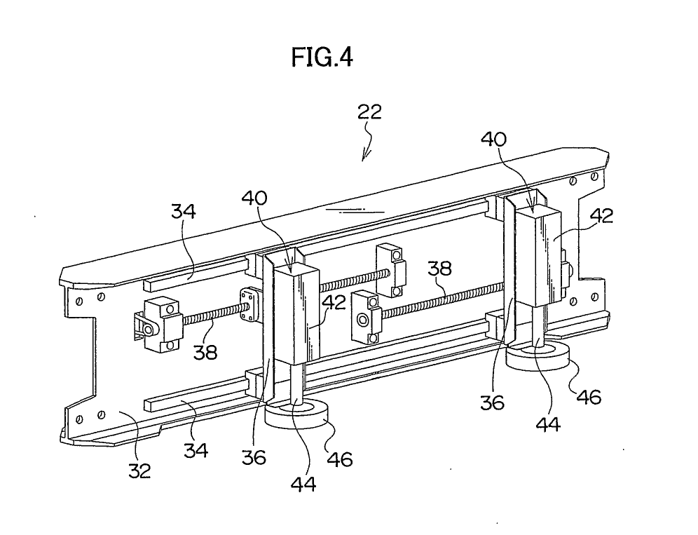

As shown in FIG. 4, the alignment section 22 has a base plate 32 which is fixed to the supporting member; a pair of guide rails 34 which are disposed at the base plate 32 and are parallel to the main scanning direction (the transverse direction); a plurality of (e.g., two) brackets 36 mounted so as to be slidable in the main scanning direction (the transverse direction) along the guide rails 34; and a plurality of (e.g., two) cameras 40 supported at the respective brackets 36.

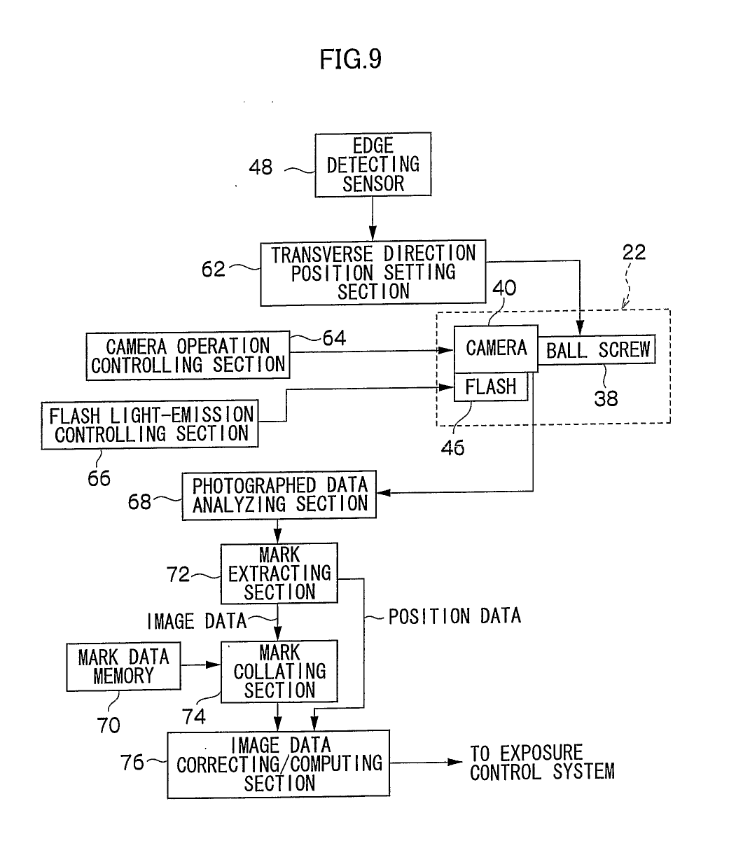

The bracket 36 can move reciprocatingly in the main scanning direction (the transverse direction) along the guide rails 34 due to the forward and reverse rotational driving of a ball screw 38 for example. A lens 44 is provided at the bottom surface of a main body portion 42 of the camera 40. A ring-shaped flash (LED flash) 46, whose light-emitting time each one time is extremely short, is mounted to the projecting distal end portion of the lens 44. The sensitivity of the camera 40 is adjusted by a camera operation controlling section 64 shown in FIG. 9, such that image pickup is possible only at times when the flash 46 emits light.

Accordingly, when the stage member 20 passes by the image pickup position which is positioned on the optical axis of each camera 40, the flash 46 is made to emit light at a predetermined time by a flash light-emission controlling section 66 shown in FIG. 9. The image pickup range, which includes the alignment mark 102, on the flexible printed circuit 100 can thereby be picked-up by the camera 40. Namely, the light from the flash 46 is illuminated onto the flexible printed circuit 100 on the stage member 20. Due to the light reflected therefrom being inputted to the main body portion 42 via the lens 44, the alignment mark 102 on the flexible printed circuit 100 is photographed.

It is preferable that the stage member 20 be temporarily stopped at the times when the alignment marks 102 are photographed. In accordance with such a structure, it is possible to eliminate configurational errors of the alignment marks 102 at the time of photographing while the stage member 20 is being moved, and it is possible to accurately compute only the positional offset amount in the conveying direction of the flexible printed circuit 100, i.e., only the ratio of the expansion/contraction due to the elongation F. Of course, detection of the alignment marks 102 may be carried out while the stage member 20 is being moved.

Each camera 40 has, as the image pickup range thereof, a different range along the transverse direction of the flexible printed circuit 100 (the main scanning direction). Due to one transverse direction (main scanning direction) end portion (edge) of the flexible printed circuit 100 which is the object of image pickup being detected by an edge detecting sensor 48 which will be described later, the positions of the plural groups of alignment marks 102 can be estimated. On the basis of this estimated data, the driving of the ball screws 38 is controlled by a transverse direction position setting section 62 shown in FIG. 9, so that the cameras 40 are disposed at predetermined positions in advance.

As shown in FIG. 9, the image recording device 10 has: a photographed data analyzing section 68 which identifies the alignment marks 102 photographed by the cameras 40; an alignment mark extracting section 72 converting the analog image data of the photographed alignment marks 102 into digital image data; an alignment mark data memory 70 storing, in advance, alignment marks which are references; an alignment mark collating section 74 comparing the alignment marks 102 extracted by the alignment mark extracting section 72 and the reference alignment marks stored in the alignment mark data memory 70; and an image data correcting/computing section 76 computing position correction data from comparison data detected by the alignment mark collating section 74 and position data obtained by the alignment mark extracting section 72.

Accordingly, the alignment marks 102, which are photographed by the cameras 40 as the stage member 20 moves in the conveying direction (along the outward trip) and passes by the alignment section 22, and which are identified by the photographed data analyzing section 68, are converted into digital image data by the alignment mark extracting section 72, and are compared with the reference alignment marks by the alignment mark collating section 74.

Then, the position correction data with respect to the elongation F in the conveying direction as shown in FIG. 10B, and the oblique feeding, and the like, is computed by the image data correcting/computing section 76. Note that the stage member 20 may be structured so as to temporarily stop when having passed by the alignment section 22 (i.e., when photographing of the alignment marks 102 of the plural groups corresponding to one image-drawing region is completed), such that the aforementioned position correction data is computed during that time.

When the position correction data of the ratio of the expansion/contraction and the like is computed in this way, correction based on this position correction data is carried out on the image data of the time of carrying out exposure by the exposure heads 30. Namely, as the stage member 20 moves to return (along the return trip) to its original position, light beams, which are modulated on the basis of this corrected image data, are irradiated by the exposure heads 30 onto the image-drawing region of the flexible printed circuit 100. In this way, the desired image can be accurately formed (recorded) on the image-drawing region of the flexible printed circuit 100.

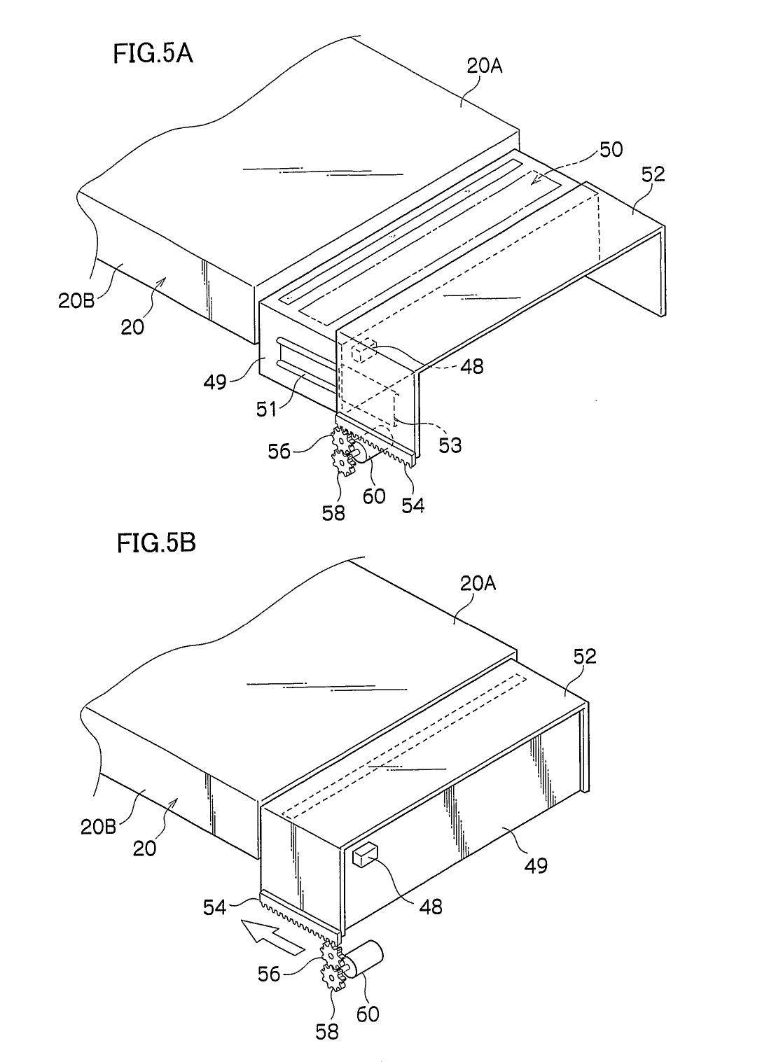

As shown in FIG. 5A, a Power Detector sensor (hereinafter called “PD sensor”) 50, which inspects the light amounts of the exposure heads 30 and the junctures and the like before the flexible printed circuit 100 is exposed (i.e., before the image is recorded on the flexible printed circuit 100), is provided integrally with the supporting body 20B via a housing 49 at the conveying direction side of the stage member 20.

As described above, the exposure heads 30 are disposed in a substantial matrix form of, for example, two lines and four columns. Therefore, the PD sensor 50 can inspect in advance whether or not gaps (portions that will be unexposed) exist at boundary portions (junctures) between the exposure heads 30. Then, the exposure amounts, the beam positions, and the like of the exposure heads 30 are adjusted on the basis of the results of this inspection. Note that the PD sensor 50 is covered by a cover 52 when not in use, i.e., when the flexible printed circuit 100 is exposed. The cover 52 is structured so as to be opened and closed automatically, but another arbitrary structure may be used therefor.

For example, as shown in FIGS. 5A and 5B, guide rails 51 are disposed at the both outer side surfaces of the housing 49. Guide rails 53, which fit-together with the guide rails 51 from the vertical direction, are provided at the both inner side surfaces of the cover 52. At the bottom portion of one side wall of the cover 52, a rack 54 is provided, and a pinion 56 which meshes with the rack 54 is provided. Moreover, a motor 60, to whose driving shaft is fixed a gear 58 which meshes with the pinion 56, is provided. With such a structure, the cover 52 can slide in the conveying direction and the subscanning direction due to the forward and reverse rotational driving of the motor 60.

As shown in FIGS. 2 and 5A, the PD sensor 50 is disposed so as to be positioned slightly lower than the stage surface 20A of the stage member 20 as seen in side view. Also when the PD sensor 50 is covered by the cover 52, the cover 52 is at a position which is slightly lower than the stage surface 20A as seen in side view. The cover 52 may be flush with the stage surface 20A, but is preferably at a position which is slightly lower than the stage surface 20A. In this way, the PD sensor 50 (the cover 52) does not contact the flexible printed circuit 100. Further, in the image recording device 10, the edge detecting sensor 48, which detects the transverse direction (main scanning direction) end portion (edge) of the flexible printed circuit 100, is provided at an appropriate position on the line of conveying of the flexible printed circuit 100.

In accordance with the results of sensing of the edge detecting sensor 48, the rotating/driving of the ball screws 38 is controlled via the transverse direction position setting section 62 (see FIG. 9), and the positions of the cameras 40 at the alignment section 22 are changed. Note that the edge detecting sensor 48 is disposed in a vicinity of the PD sensor 50, and due to the PD sensor 50 being covered by the cover 52, the edge detecting sensor 48 can detect the edge of the flexible printed circuit 100.

[Operation of Image Recording Device]

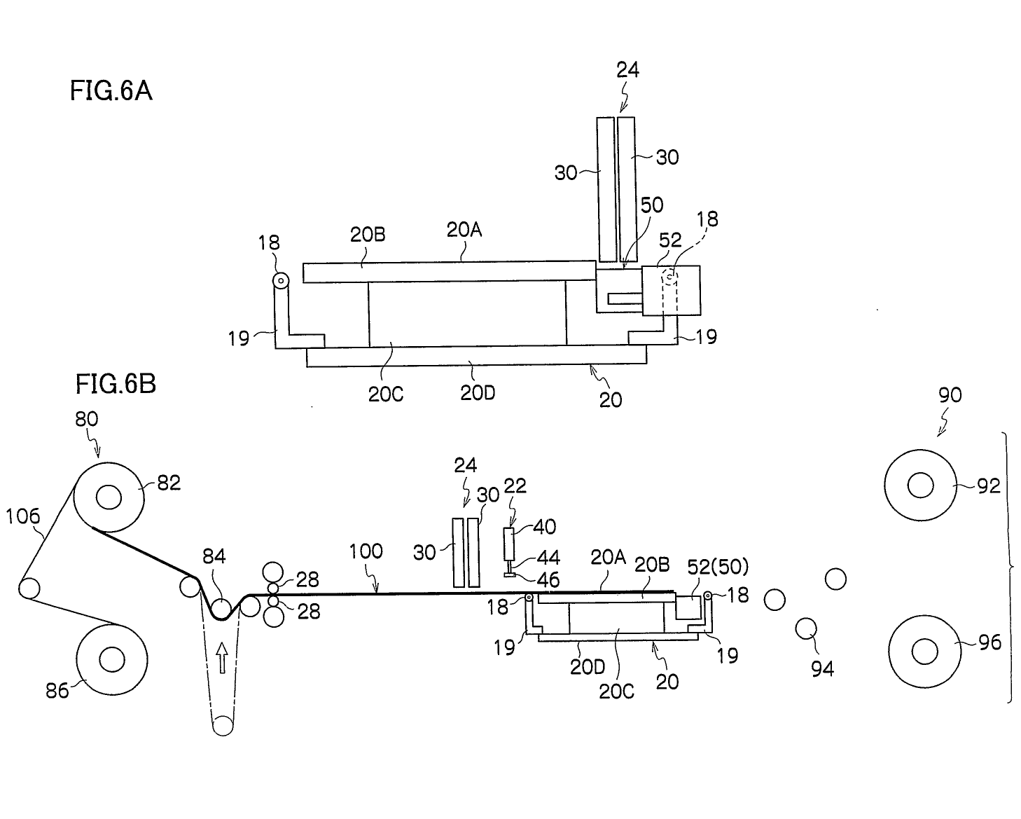

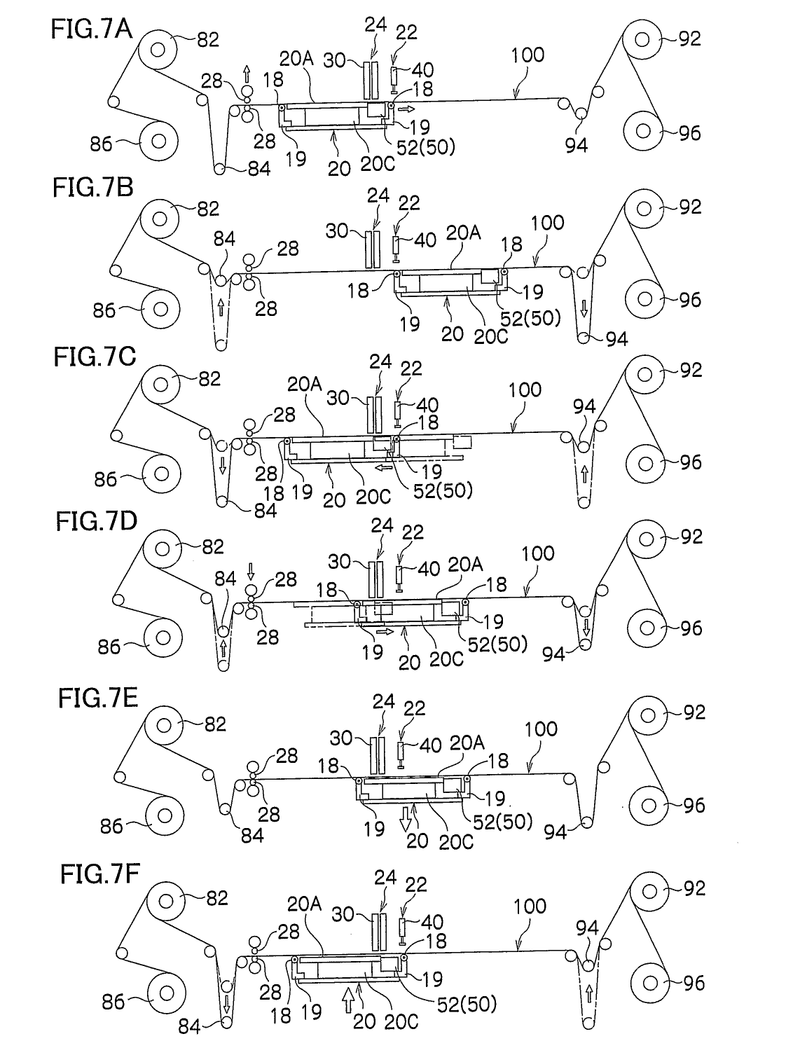

Next, the operation of the image recording device 10, which has the above-described structure, will be described mainly on the basis of FIGS. 6A and 6B, and FIGS. 7A through 7F. First, as shown in FIG. 6A, the supporting body 20B is raised by the raising/lowering mechanism 20C, and the PD sensor 50 is disposed at the exposure position of the exposure heads 30 with respect to the flexible printed circuit 100. The height by which the supporting body 20B (the stage surface 20A) is raised at this time is equal to the difference in the heights of the stage surface 20A and the PD sensor 50.

Then, as shown in FIG. 5A, the motor 60 is rotated, and the cover 52 is slid in the conveying direction via the gear 58, the pinion 56, and the rack 54, so as to open the PD sensor 50. In this way, the light amounts and junctures of the exposure heads 30 are inspected, and, if necessary, are adjusted. Note that, when the cover 52 is open, the height thereof is slightly higher than the height of the guide roller 18. Therefore, the cover 52 slides above the guide roller 18 and does not interfere with the guide roller 18.

When the inspection and adjustment of the exposure heads 30 is completed, as shown in FIG. 5B, the motor 60 is rotated reversely, and the cover 52 is slid in the subscanning direction. Then, due to the raising/lowering mechanism 20C lowering the supporting body 20B, the stage surface 20A is lowered. Next, as shown in FIG. 6B, the leading end of the flexible printed circuit 100, which is in the form of a roll and which is set at the supply reel 82 of the loader 80, is trained about the dancer roller 84, is passed between the cleaning rollers 28, and is suctioned to the stage surface 20A of the stage member 20 by the suctioning of air from the small holes.

Thereafter, when the stage member 20 is moved in the conveying direction along the guide rails 16 and is stopped at a predetermined position, the suctioning of air from the small holes is cancelled. The leading end of the flexible printed circuit 100 is peeled off from the stage surface 20A of the stage member 20, and is trained about the dancer roller 94 at the unloader 90 side. Thereafter, the leading end of the flexible printed circuit 100 is attached to the take-up reel 92. At this time, the leading end of protective film 106, which is pulled-out from the feed-out reel 96, is attached to the leading end of the flexible printed circuit 100.

Although this work depends on the manual operation of the operator, because the PD sensor 50 is covered by the cover 52 at this time, there is no fear of a human hand contacting the PD sensor 50. Because the PD sensor 50 is an extremely delicate optical system, it is apt to be disrupted by dirt. Accordingly, at the time of the work of manually attaching the flexible printed circuit 100 to the take-up reel 92, the PD sensor 50 is covered by the cover 52 so as to not be touched by a human hand. Further, at this time, the cleaning rollers 28 slidingly contact the flexible printed circuit 100. In this way, the initial image-drawing region is cleaned.

When the work of attaching the flexible printed circuit 100 to the take-up reel 92 is completed, the stage surface 20A (the supporting body 20B) is lowered a predetermined height by the raising/lowering mechanism 20C, and the stage member 20 moves along the guide rails 16 in the subscanning direction. At this time, because the heights of the guide rollers 18 are invariable, the guide rollers 18 contact the flexible printed circuit 100 from the reverse surface (bottom surface) side thereof, and support the flexible printed circuit 100. Accordingly, even if the flexible printed circuit 100 flexes, it does not contact (slidingly contact) the stage surface 20A. Note that, when the guide rollers 18 move together with the stage member 20, they rotate following the movement of the flexible printed circuit 100 due to the friction caused by the contact between the guide rollers 18 and the flexible printed circuit 100.

When the flexible printed circuit 100 is stretched in this way between the loader 80 and the unloader 90 and the stage member 20 is moved to a predetermined position and stopped, as shown in FIG. 7A, the cleaning rollers 28 are moved away from the flexible printed circuit 100. The stage surface 20A (the supporting body 20B) is raised a predetermined height by the raising/lowering mechanism 20C, and the initial image-drawing region of the flexible printed circuit 100 is suctioned to the stage surface 20A. At this time, the dancer roller 84 is at the lowered position, and the dancer roller 94 is at the raised position. Further, the guide rollers 18 are separated from the reverse surface (the bottom surface) of the flexible printed circuit 100.

At this time, because the PD sensor 50, which is covered by the cover 52, is disposed a predetermined height lower than the stage surface 20A, the cover 52 (the PD sensor 50) does not contact the reverse surface of the flexible printed circuit 100. Accordingly, there is no fear that the PD sensor 50, which is a delicate optical system, will be dirtied by the flexible printed circuit 100. Further, at this time, the edge of the flexible printed circuit 100 is detected by the edge detecting sensor 48.

When the stage surface 20A of the stage member 20 suctions the image-drawing region of the flexible printed circuit 100 in this way, in this suctioning state, the stage member 20 is moved at a predetermined speed in the conveying direction along the guide rails 16, and the image-drawing region of the flexible printed circuit 100 is conveyed in the same direction. Then, as shown in FIG. 7B, the stage member 20 passes by the exposure section 24, and then passes by the alignment section 22.

When the stage member 20 passes by the alignment section 22, the alignment marks 102 of the flexible printed circuit 100 and the image-drawing region in the vicinity thereof are photographed by the cameras 40. Namely, the flashes 46 are made to emit light by the flash light-emission controlling section 66, and the cameras 40 are operated by the camera operation controlling section 64.

At this time, because the edge of the flexible printed circuit 100 is detected by the edge detecting sensor 48, on the basis of these results of detection, the cameras 40 have already been moved to predetermined positions by the transverse direction position setting section 62. Namely, rotation of the ball screws 38 is controlled, such that the positions of the cameras 40 in the main scanning direction (the transverse direction) are adjusted. Further, as the stage member 20 moves, the dancer roller 84 rises and the dancer roller 94 falls. The tension with respect to the flexible printed circuit 100 which is being conveyed is thereby adjusted so as to be constant.

When the alignment marks 102 and the image-drawing region in the vicinity thereof are photographed by the cameras 40, the photographed data analyzing section 68 identifies only the alignment marks 102, and this photographed data is converted into digital image data by the alignment mark extracting section 72. Then, the alignment mark collating section 74 compares this digital image data with the reference alignment marks stored in the alignment mark data memory 70. On the basis of the obtained comparison data and the position data obtained by the alignment mark extracting section 72, the image data correcting/computing section 76 computes position correction data for the image data to be recorded in the image-drawing region.

Namely, correction factors of the exposure start position in the subscanning direction in which the stage member 20 moves, the dot shift positions in the main scanning direction and the subscanning direction of the stage member 20, and the like are computed. On the basis of these correction factors, correction ratios and the like are computed for the positional offset of the flexible printed circuit 100 in the transverse direction (the main scanning direction), positional offset in the conveying direction (or the subscanning direction), oblique feeding, and the like. Note that the positional offset in the conveying direction (or the subscanning direction) is shown in an exaggerated manner in FIG. 10B, and is, for example, an elongation F of about 10 μm with respect to a 500 mm length of the image-drawing region in the conveying direction, or the like.

At this time, the stage member 20 is moved to a position at which the alignment section 22 reaches the region above the guide roller 18 at the subscanning direction side (i.e., the stage member 20 is moved a distance which is greater than or equal to the distance needed for exposure). Namely, alignment processing at one image-drawing region is completed before exposure processing. Accordingly, the position correction data of the image data can be computed accurately, and the image data can be corrected accurately.

When the photographing of the alignment marks 102 by the alignment section 22 is completed, the stage member 20 is stopped temporarily. During this time when the stage member 20 is stopped, the aforementioned position correction data is computed, and the image data to be exposed at the exposure section 24 is corrected on the basis of this computed position correction data.

Thereafter, as shown in FIG. 7C, with the flexible printed circuit 100 remaining suctioned thereto, the stage member 20 is moved so as to return at a predetermined speed in the subscanning direction, and passes by the alignment section 22, and then passes by the exposure section 24. Namely, in the exposure section 24, the light beams, which are modulated by the DMDs which are controlled on and off on the basis of the corrected image data, are irradiated from the exposure heads 30 and focused, and expose the image-drawing region of the flexible printed circuit 100. Accordingly, the desired image is formed (recorded) accurately in the image-drawing region of the flexible printed circuit 100.

Note that the movement of the stage member 20 may be started before the correcting of the image data is completed. Further, at this time, as the stage member 20 moves, the dancer roller 84 falls and the dancer roller 94 rises. The tension with respect to the flexible printed circuit 100 which is being conveyed is thereby adjusted so as to be constant. Further, because the alignment section 22 is disposed at the downstream side, in the conveying direction of the flexible printed circuit 100, of the exposure section 24, the carrying out of alignment processing on the outward trip and the carrying out of image recording processing on the return trip are executed efficiently.

When the image is formed in the image-drawing region of the flexible printed circuit 100 by the exposure heads 30, the stage member 20 is again stopped temporarily. At this time, the stage member 20 is moved to a position at which the exposure section 24 reaches the region above the PD sensor 50 which is covered by the cover 52 (i.e., the stage member 20 is moved a distance which is greater than or equal to the distance needed for exposure). Accordingly, the entire, one image-drawing region can be exposed accurately. Then, as shown in FIG. 7D, the stage member 20 again moves in the conveying direction with the flexible printed circuit 100 remaining suctioned thereto.

With such a structure in which the exposed image-drawing region of the flexible printed circuit 100 is conveyed and discharged only by the stage member 20, there is the advantage that there is no need to provide a separate mechanism for discharging the flexible printed circuit 100. Note that, at this time, the cleaning rollers 28 slidingly contact the flexible printed circuit 100 and clean the next image-drawing region of the flexible printed circuit 100. Further, as the stage member 20 moves, the dancer roller 84 rises and the dancer roller 94 falls. The tension with respect to the flexible printed circuit 100 which is being conveyed is thereby adjusted so as to be constant.

Then, when the next image-drawing region is conveyed to a predetermined position, the stage member 20 is stopped, and the stage surface 20A thereof releases the suctioning of the flexible printed circuit 100. At this time, the dancer rollers 84 and 94 stop at predetermined positions respectively. Then, as shown in FIG. 7E, the stage surface 20A of the stage member 20 is lowered a predetermined height by the raising/lowering mechanism 20C.

At this time, the heights of the guide rollers 18, which are provided at the both sides of the stage member 20, are invariable. Therefore, the guide rollers 18 support the flexible printed circuit 100 from the reverse surface side thereof. Accordingly, even if the flexible printed circuit 100 flexes, it does not contact the stage surface 20A.

The stage surface 20A which releases the suctioning of the flexible printed circuit 100, and which is lowered by a predetermined height moves in the subscanning direction. At this time, because the guide rollers 18 are contacting the reverse surface of the flexible printed circuit 100, due to friction, they move while rotating following the movement of the stage member 20. When the stage member 20 has returned to a predetermined position, the unexposed flexible printed circuit 100 is pulled-out due to the supply reel 82 rotating, and the dancer roller 84 falls.

When the dancer roller 84 reaches a predetermined lower position, a sensor (not shown) turns on, and the rotational driving of the supply reel 82 thereby stops. Further, at this time, the take-up reel 92 takes-up the flexible printed circuit 100. Accompanying this operation of taking-up, the dancer roller 94 rises. Note that the supply reel 82, the take-up reel 92, and the dancer rollers 84, 94 may operate while the stage member 20 is moving in the subscanning direction.

Thereafter, as shown in FIG. 7F, the stage surface 20A of the stage member 20 is raised a predetermined height by the raising/lowering mechanism 20C, and the reverse surface of the flexible printed circuit 100 where the next image-drawing region exists is suctioned to and held at the stage surface 20A. By repeating the operations of FIGS. 7A through 7F again in this way, images are successively formed (recorded) on the image-drawing regions of the flexible printed circuit 100.

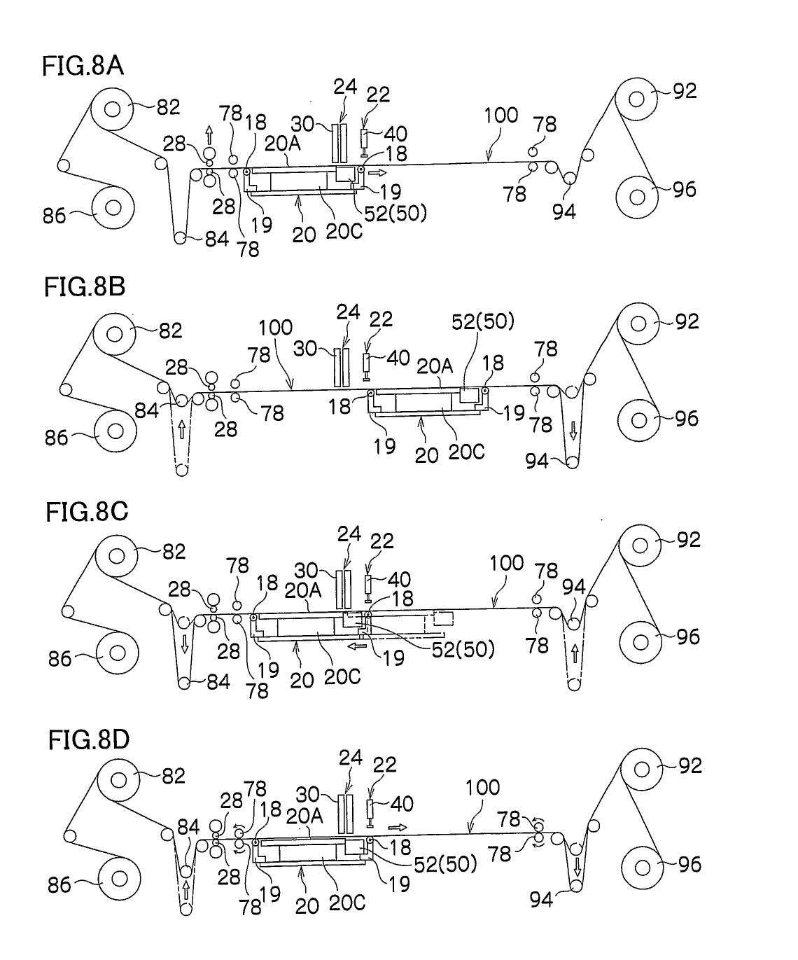

Next, a variant example of the image recording device 10 shown in FIGS. 8A through 8D will be described. As shown in FIGS. 8A through 8D, conveying rollers 78, which are structured so as to be able to rotated and driven, are disposed at the conveying direction side of the cleaning rollers 28 and at the subscanning direction side of the dancer roller 94. The conveying rollers 78 are for conveying and discharging, in the conveying direction, the exposed image-drawing region of the flexible printed circuit 100. In this way, there is the effect that the tact time for processing one image-drawing region can be reduced as compared with the above-described embodiment of FIGS. 7A through 7F, by the amount by which there is no need to convey and discharge the flexible printed circuit 100 by moving the stage member 20 as in the above-described embodiment. Hereinafter, operation of this variant example will be described, but contents which are the same as those described above will be omitted appropriately.

When the cleaning rollers 28 have cleaned the image-drawing region of the flexible printed circuit 100 stretched between the loader 80 and the unloader 90, as shown in FIG. 8A, the cleaning rollers 28 move away from the flexible printed circuit 100. At this time, it is preferable that the conveying rollers 78 as well be apart from the flexible printed circuit 100.

At this time, the dancer roller 84 is at the lower position, and the dancer roller 94 is at the upper position. Then, the stage surface 20A (the supporting body 20B) of the stage member 20 is raised a predetermined height by the raising/lowering mechanism 20C, the image-drawing region of the flexible printed circuit 100 is suctioned to the stage surface 20A, and the guide rollers 18 are separated from the reverse surface of the flexible printed circuit 100.

Further, at this time, because the PD sensor 50 which is covered by the cover 52 is disposed a predetermined height lower than the stage surface 20A, the cover 52 (the PD sensor 50) does not contact the reverse surface of the flexible printed circuit 100. Accordingly, there is no fear that the PD sensor 50, which is a delicate optical system, will be dirtied by the flexible printed circuit 100. Further, at this time, the edge of the flexible printed circuit 100 is detected by the edge detecting sensor 48.

When the stage surface 20A of the stage member 20 suctions the image-drawing region of the flexible printed circuit 100 in this way, in this suctioning state, the stage member 20 is moved at a predetermined speed in the conveying direction along the guide rails 16, and the image-drawing region of the flexible printed circuit 100 is conveyed in the same direction. Then, as shown in FIG. 8B, the stage member 20 passes by the exposure section 24, and then passes by the alignment section 22.

When the stage member 20 passes by the alignment section 22, the alignment marks 102 of the flexible printed circuit 100 and the image-drawing region in the vicinity thereof are photographed by the cameras 40. Namely, the flashes 46 are made to emit light by the flash light-emission controlling section 66, and the cameras 40 are operated by the camera operation controlling section 64.

At this time, because the edge of the flexible printed circuit 100 is detected by the edge detecting sensor 48, on the basis of these results of detection, the cameras 40 are moved to predetermined positions by the transverse direction position setting section 62. Namely, rotation of the ball screws 38 is controlled, such that the positions of the cameras 40 in the main scanning direction (the transverse direction) are adjusted. Further, as the stage member 20 moves, the dancer roller 84 rises and the dancer roller 94 falls. The tension with respect to the flexible printed circuit 100 which is being conveyed is thereby adjusted so as to be constant.

When the alignment marks 102 and the image-drawing region in the vicinity thereof are photographed by the cameras 40, the photographed data analyzing section 68 identifies only the alignment marks 102, and this data is converted into digital image data by the alignment mark extracting section 72. Then, on the basis of the position data obtained by the alignment mark extracting section 72 and comparison data obtained by the alignment mark collating section 74 for comparing the digital image data with the reference alignment marks stored in the alignment mark data memory 70, the image data correcting/computing section 76 computes position correction data for the image data to be recorded in the image-drawing region.

Namely, correction factors of the exposure start position in the subscanning direction in which the stage member 20 moves, the dot shift positions in the main scanning direction and the subscanning direction of the stage member 20, and the like are computed. On the basis of these correction factors, correction ratios and the like are computed for the positional offset of the flexible printed circuit 100 in the transverse direction (the main scanning direction), positional offset in the conveying direction (or the subscanning direction), oblique feeding, and the like. Note that the positional offset in the conveying direction or the subscanning direction is shown in an exaggerated manner in FIG. 10B, and is, for example, the elongation F of about 10 μm with respect to a 500 mm length of the image-drawing region in the conveying direction, or the like.

At this time, the stage member 20 is moved to a position at which the alignment section 22 reaches the region above the guide roller 18 at the subscanning direction side (i.e., the stage member 20 is moved a distance which is greater than or equal to the distance needed for exposure). Namely, alignment processing at one image-drawing region is completed before exposure processing. Accordingly, the position correction data of the image data can be computed accurately, and the image data can be corrected accurately.

When the photographing of the alignment marks 102 by the alignment section 22 is completed, the stage member 20 is stopped temporarily. During this time when the stage member 20 is stopped, the aforementioned position correction data is computed, and the image data to be exposed at the exposure section 24 is corrected on the basis of this computed position correction data.

Thereafter, as shown in FIG. 8C, with the flexible printed circuit 100 remaining suctioned thereto, the stage member 20 is moved so as to return at a predetermined speed in the subscanning direction, and passes by the alignment section 22, and then passes by the exposure section 24. Namely, in the exposure section 24, the light beams, which are modulated by the DMDs which are controlled on and off on the basis of the corrected image data, are irradiated from the exposure heads 30 and focused, and expose the image-drawing region of the flexible printed circuit 100. Accordingly, the desired image is formed accurately in the image-drawing region of the flexible printed circuit 100.

Note that the movement of the stage member 20 may be started before the correcting of the image data is completed. Further, at this time, as the stage member 20 moves, the dancer roller 84 falls and the dancer roller 94 rises. The tension with respect to the flexible printed circuit 100 which is being conveyed is thereby adjusted so as to be constant. Further, because the alignment section 22 is disposed at the downstream side, in the conveying direction of the flexible printed circuit 100, of the exposure section 24, the carrying out of alignment processing on the outward trip and the carrying out of image recording processing on the return trip are executed efficiently.

When the image is formed in the image-drawing region of the flexible printed circuit 100 by the exposure heads 30, the stage member 20 is again stopped temporarily. At this time, the stage member 20 is moved to a position at which the exposure section 24 reaches the region above the PD sensor 50 which is covered by the cover 52 (i.e., the stage member 20 is moved a distance which is greater than or equal to the distance needed for exposure). Accordingly, the entire, one image-drawing region can be exposed accurately. Then, as shown in FIG. 8D, the stage surface 20A of the stage member 20 releases the suctioning of the flexible printed circuit 100, and is lowered a predetermined height by the raising/lowering mechanism 20C.

At this time, the heights of the guide rollers 18 provided at the both sides of the stage member 20 are invariable. Therefore, the guide rollers 18 support the flexible printed circuit 100 from the reverse surface side thereof. Accordingly, even if the flexible printed circuit 100 flexes, it does not contact the stage surface 20A. Further, the conveying rollers 78 contact the flexible printed circuit 100 in a state in which there is friction. Due to the conveying rollers 78 rotating and driving in the rotating directions shown in FIG. 8D, the conveying rollers 78 convey the flexible printed circuit 100 by a predetermined distance, i.e., discharge one image-drawing region.

Moreover, at this time, because the guide rollers 18 are contacting the reverse surface of the flexible printed circuit 100, due to this friction, the guide rollers 18 rotate following the conveying of the flexible printed circuit 100. Further, at this time, the cleaning rollers 28 as well slidingly contact the flexible printed circuit 100, and clean the next image-drawing region of the flexible printed circuit 100. In addition, accompanying the conveying of the flexible printed circuit 100, the dancer roller 84 rises and the dancer roller 94 falls. The tension with respect to the flexible printed circuit 100 which is being conveyed is thereby adjusted so as to be constant.

Then, when the next image-drawing region is conveyed onto the stage surface 20A of the stage member 20, the rotating and driving of the conveying rollers 78 is stopped, and the conveying rollers 78 move away from the flexible printed circuit 100. At this time, due to the supply reel 82 rotating, the unexposed flexible printed circuit 100 is pulled-out, and the dancer roller 84 falls. When the dancer roller 84 reaches a predetermined lower position, the sensor (not shown) turns on, and the rotational driving of the supply reel 82 thereby stops.

Further, at this time, the take-up reel 92 takes-up the flexible printed circuit 100. Accompanying this operation of taking-up, the dancer roller 94 rises a predetermined height. Thereafter, the stage surface 20A of the stage member 20 is raised a predetermined height by the raising/lowering mechanism 20C, and the reverse surface (bottom surface) of the flexible printed circuit 100 where the next image-drawing region exists is suctioned to and held at the stage surface 20A. By repeating the operations of FIGS. 8A through 8D again in this way, images are successively formed on the image-drawing regions of the flexible printed circuit 100.

In either case, because the flexible printed circuit 100 is conveyed while being suctioned at the stage member 20, the occurrence of oblique feeding and wrinkles can be prevented, and highly accurate conveying can be realized. Further, because the alignment processing is carried out on the outward trip and the image recording processing is carried out on the return trip, at one image-drawing region, the alignment processing can be completed before the image recording processing. Accordingly, the image data can be corrected accurately, and the desired image can be recorded accurately on the flexible printed circuit 100.

Namely, after an entire, one image-drawing region of the flexible printed circuit 100 is confirmed ahead by the alignment section 22, the position correction data is computed, and exposure is carried out with the image data corrected on the basis of this computed position correction data. Therefore, the accuracy of exposure can be improved. Accordingly, it is possible to carry out exposure while dealing with not only oblique feeding of the flexible printed circuit 100, but also positional offset (the elongation F) in the conveying direction (and the subscanning direction) of the flexible printed circuit 100. Therefore, the product quality and reliability can be improved.

In the above-described embodiment, explanation is given of a case in which DMDs serve as spatial light modulators, but the present invention is not limited to the same. Other than such a reflecting-type spatial light modulator, a transmitting-type spatial light modulator (LCD) can be used. For example, a MEMS (Micro Electro Mechanical System) type spatial light modulator (SLM), or a spatial light modulator other than a MEMS type, such as an optical element which modulates transmitted light in accordance with the electrooptical effect (a PLZT element), or a liquid crystal shutter array like a liquid crystal light shutter (FLC), or the like may be used.

Note that “MEMS” collectively refers to minute systems in which micro-sized sensors, actuators and control circuits, which are formed by micromachining techniques based on IC manufacturing processes, are integrated. A MEMS type spatial light modulator means a spatial light modulator which is driven by electromechanical operation using static electricity. Moreover, a structure in which a plurality of grating light valves (GLVs) are lined-up in a two-dimensional form can be used. In structures using reflecting-type spatial light modulators (GLVs) and transmitting-type spatial light modulators (LCDs), a lamp or the like can be used as the light source, rather than the aforementioned laser.

A fiber array light source having a plurality of multiplex laser light sources; a fiber array light source in which fiber light sources, each of which has one optical fiber from which exits laser light which is incident from a single semiconductor laser having one light-emitting point, are set in the form of an array; a light source in which a plurality of light-emitting points are arranged in two dimensions (e.g., an LD array, an organic EL array, and the like); or the like can be used as the light source in the above-described embodiment. Further, the above-described embodiment is structured such that images are recorded by using the exposure heads 30, but the present invention is not limited to the same. For example, the present invention is also applicable to structures in which images are recorded by using inkjet recording heads (not illustrated).

1. An image recording device for recording an image on an image-drawing region of a strip-shaped flexible substrate stretched between a supply reel and a take-up reel, the device comprising:
a conveying path of the flexible substrate provided between the supply reel and the take-up reel;
a stage section for suctioning the flexible substrate, and structured so as to be reciprocatingly movable along the conveying path;
an alignment section disposed at the conveying path above the stage section, and which, on a outward trip of the stage section, senses at least an alignment mark of the flexible substrate;
a correcting section which, on the basis of the alignment mark sensed by the alignment section, corrects image data to be recorded on the image-drawing region of the flexible substrate; and
a recording section disposed at the conveying path above the stage section, and which, on a return trip of the stage section, records the image data corrected by the correcting section at the image-drawing region of the flexible substrate.

2. The image recording device of claim 1, wherein the correcting section at least computes a positional offset correction amount with respect to a conveying direction of the flexible substrate.

3. The image recording device of claim 1, wherein the recording section and the alignment section are disposed in that order from the supply reel side.

4. The image recording device of claim 1, wherein the flexible substrate is conveyed-in and discharged-out with the image-drawing region of the flexible substrate suctioned to the stage section.

5. The image recording device of claim 1, wherein the flexible substrate is conveyed to the stage section and discharged from the stage section by conveying rollers.

6. The image recording device of claim 1, wherein the recording section has an exposure head which exposes the flexible substrate and records the image data.

7. The image recording device of claim 6, wherein the exposure head irradiates a light beam, which is modulated on the basis of the image data, and exposes the flexible substrate.

8. The image recording device of claim 1, wherein the correcting section comprises:
an alignment mark memory for storing a reference alignment mark;
an alignment mark collating section for comparing the alignment mark sensed at the alignment section with the reference alignment mark; and
an image data correcting/computing section for computing an amount of correction of the image data from results of comparison at the alignment mark collating section.

9. The image recording device of claim 1, wherein the alignment section comprises at least one camera, and the alignment mark is sensed by the flexible substrate being photographed.

10. An image recording method for recording an image on an image-drawing region of a strip-shaped flexible substrate stretched between a supply reel and a take-up reel, the method comprising:
moving, along a predetermined conveying path, a stage section for suctioning the flexible substrate;
sensing, by an alignment section, at least an alignment mark of the flexible substrate;
on the basis of the sensed alignment mark, correcting image data to be recorded on the image-drawing region of the flexible substrate; and
recording, by a recording section, corrected image data on the image-drawing region of the flexible substrate, while moving the stage section in an opposite direction.

11. The image recording method of claim 10, wherein the correcting at least includes computing a positional offset correction amount with respect to a conveying direction of the flexible substrate.

12. The image recording method of claim 10, wherein the recording section and the alignment section are disposed in that order from the supply reel side.

13. The image recording method of claim 10, wherein the flexible substrate is conveyed-in and discharged-out with the image-drawing region of the flexible substrate suctioned to the stage section.

14. The image recording method of claim 10, wherein the flexible substrate is conveyed to the stage section and discharged from the stage section by conveying rollers.

15. The image recording method of claim 10, wherein the recording section comprises an exposure head which exposes the flexible substrate and records the image data.

16. The image recording method of claim 15, wherein the exposure head irradiates a light beam, which is modulated on the basis of the image data, and exposes the flexible substrate.

17. The image recording method of claim 10, wherein the correcting includes:
storing a reference alignment mark in advance;
comparing the sensed alignment mark and the reference alignment mark; and
computing an amount of correction of the image data from results of comparison.

18. The image recording method of claim 10, wherein the alignment section comprises at least one camera, and the alignment mark is sensed by the flexible substrate being photographed.
